(19) United States
(12) Patent Application Publication
(10) Pub. No.: US 2021/0170815 A1
(43) Pub. Date: Jun. 10, 2021

(54) INFLATION VALVE FOR TYRE RIM WITH LIMITATION OF ELASTIC DEFORMATION

(71) Applicants: Continental Automotive France, Toulouse (FR); Continental Automotive GmbH, Hannover (DE)

(72) Inventors: Jérémy Mieyan, Saiguede (FR); Thibaut Thiourt, Toulouse (FR); Pascal Petitjean, Saint Thomas (FR)

(21) Appl. No.: 16/770,304

(22) PCT Filed: Dec. 13, 2018
(86) PCT No.: PCT/FR2018/053282

§ 371 Date: Jun. 5, 2020

(30) Foreign Application Priority Data
Dec. 21, 2017 (FR) 1762800

(51) Int. Cl. B60C 29/00; B60C 29/02; B60C 23/04

(52) U.S. Cl. CPC B60C 29/005; B60C 23/0494; B60C 29/02

(57) ABSTRACT

An inflation valve intended to be installed in a wheel rim orifice of a vehicle, the valve being of the elastic deformation type having a valve body made of an elastomer material and a hollow rigid tube. The inflation valve includes a device able to be fixed on the hollow rigid tube and having a portion allowing a rotational movement of the valve in a first rotational direction when the inflation valve is mounted in a hole of the rim, and a portion preventing the rotational movement of the valve in a second rotational direction opposite the first rotational direction, the resulting device acting to limit an elastic deformation of the valve.

### CROSS REFERENCE TO RELATED APPLICATIONS

This application is the U.S. National Phase Application of PCT International Application No. PCT/FR2018/053282, filed Dec. 13, 2018, which claims priority to French Patent Application No. 1762800, filed Dec. 21, 2017, the contents of such applications being incorporated by reference herein.

### FIELD OF THE INVENTION

The present invention relates to an inflation valve intended to be placed in a tyre rim orifice of a motor vehicle, the valve being of the type with elastic deformation, this inflation valve having a means for limiting a deformation of an elastic portion of the valve, wherein such deformation may lead to leaks of the valve during travel of the motor vehicle. The present invention also relates to an assembly of a tyre rim of a motor vehicle and of such an inflation valve.

Such a valve has a tubular core adapted to form an internal air passage from an external longitudinal end of the valve to an internal longitudinal end, external and internal being considered relative to the interior and exterior of a rim through which such a valve passes. The tubular core is at least partially surrounded by a sleeve of elastically deformable material from a longitudinal central portion toward the internal longitudinal end of the valve. The sleeve has the shape of a bulb that widens in proximity to the internal longitudinal end of the valve and ends with an internal longitudinal bulb end. It is the deformation of the bulb at the rim orifice, mainly when the motor vehicle is traveling, that an aspect of the present invention intends to limit.

### BACKGROUND OF THE INVENTION

Such inflatable valves with elastic deformation, also known as “snap in” valves, are widely used. Such valves may be combined with an electronic module for monitoring one or more operating parameters of the tyre such as, for example, its pressure, its temperature and/or its rotation speed.

It is thus known that operating parameters of a wheel of a motor vehicle are measured by one or more sensors mounted in electronic modules, called electronic units for measuring operating parameters of a wheel tyre or wheel units. These sensors may, for example and without restriction, be a pressure sensor in a tyre mounted on a wheel and/or a radial acceleration sensor making it possible to determine the speed of rotation of the wheel.

In a known manner, wheel units generally include a microprocessor, a memory, a radiofrequency transmitter, a power-supply battery and at least one radial acceleration sensor capable of measuring the radial accelerations of the wheel, this radial acceleration sensor being mounted on a support forming a printed circuit board. The radial acceleration measurements are sent via radiofrequency by a radiofrequency wave emission device, frequently combined with the acceleration sensor, to a central system for monitoring the operating parameters of each wheel, and in particular its rotation speed, called a central wheel control unit, the central monitoring system being inside the motor vehicle. This radiofrequency transmission device has antennas oriented precisely toward the central monitoring system so as to optimize transmissions. It follows that such valves comprise a housing accommodating all the necessary electronics.

The inflation valve associated with this electronic module is conventionally of two types. Either it is a metal inflation valve screwed into an orifice in a wheel of the vehicle, or it is a valve with elastic deformation which is forced into the orifice of the rim by deformation of the elastic material forming its body. An aspect of the present invention relates more particularly to a valve with elastic deformation.

Such an inflation valve 1 associated with an electronic unit B is illustrated in FIGS. 1 and 2.

This inflation valve comprises:
a valve body 3 made of an elastomer material, provided with a longitudinal axial bore and intended to extend through an orifice made in the rim J, said valve body being made up of an elastically deformable trunk 3a and of an abutment head 3b for butting against the rim, which head is separated from the trunk by a neck 3c designed to become positioned in airtight fashion in the orifice made in said rim J, and
a hollow rigid tube 4 extending in the valve body, extended by an assembly section 5 in the extension of the abutment head 3b of said valve body 3, and equipped at its end opposite the assembly portion with a thread for receiving a valve cap 6,
   said valve body 3 and said hollow rigid tube 4 being designed and assembled so as to allow an elastic deformation of the trunk of the valve body in order to allow installation of the inflation valve 1 through the orifice of the rim J.

The concept of a valve with elastic deformation used hitherto for a tyre pressure sensor consists in fixing the housing containing the electronics to a brass tubular core. This is a rigid connection made by screws or another system, for example, a metal clip.

The valve has two main functions: sealing during the life of the valve and sealing of the electronic elements that the valve contains, and ensuring one-step rim mounting. The two embodiments existing today are rigid fixing by screws, and the presence of a clearance between the valve and the housing.

The second embodiment involves a telescopic connection without clearance between the valve and the housing with a metal-clip fixing system. In the first embodiment of a fixing of the housing to the valve by a screw, the main drawback is having to preserve an approximately 5 mm gap between the rear of the valve and the housing, in order firstly to absorb the movements of the rubber bulb when inserting the valve into the orifice in the rim, and secondly to not be able to mount the valve on an extended rim panel with a sheet thickness of 1 mm up to a 5 mm aluminum rim.

The necessary presence of this gap reduces the dynamic performance of the valve as a wheel unit during travel because of centrifugal force.

In both cases, during travel, the rubber bulb of the valve will stretch more and more until a leak “f” (see FIG. 1) or a tear “d” in the rubber (see FIG. 2) occurs, thus limiting performance levels at high speed. A valve with elastic deformation then no longer even fulfils the required qualities specific to a valve, which are mainly to provide a seal between the air contained in the tyre and the outside.

In addition, such elastically deformable valves have the particular feature of comprising a sealing groove in which an edge portion of an orifice provided on the rim will be inserted when the valve is placed on the wheel of the vehicle. The part of the rim received in the sealing groove is of varying thickness depending on vehicle model and chosen rim size.

In a known manner, the majority of current rims measure from 1.5 mm to 5 mm in thickness, the most common thickness, for reasons of materials costs, being of the order of 2 mm. A thickness of less than 2 mm is detrimental to guaranteeing sealing of the valve.

The problem underlying the present invention is, for a valve with elastic deformation having a bulb of deformable material inserted at least partially into a tyre rim orifice in a motor vehicle, that of limiting the elastic deformation of the bulb once it is positioned on the rim.

To remedy this problem, devices for limiting the effect of centrifugal force have been proposed of the type of those described in documents US2013233068, US2008314488 or GB2526893, each incorporated by reference herein, namely devices which can be screwed onto a thread fitted to the body of a snap-in type valve or to an end of said valve (on the thread dedicated to a valve cap, as a replacement for the latter). These devices extend longitudinally over the length of the valve body corresponding to the part made of elastic material and surround the part of the rubber bulb facing the outer face of the rim. These devices are installed in order to limit the deformation effects of the snap-in valve which is subjected to centrifugal force when the wheel on which the valve is mounted rotates.

The drawback of these devices is that they solve the problem of sealing during travel but are not suitable for a valve equipped with an electronic unit of a tyre pressure monitoring system.

In fact these electronic units offer a significant and undesirable catch point during tyre fitting operations. Since the valve and the electronic unit are already in place on the rim when the tyre is fitted, in unfavorable cases the lip of the tyre may catch the electronic unit and damage it. The lip of the tyre may also exert a force on the electronic unit so as to move the latter towards the bed of the rim. The valve with an elastic deformation capacity will be angled in the hole of the rim under the force of the tyre resting on the electronic unit.

To remedy this, the devices of the prior art are made of a non-deformable material, for example of hard plastic, and bear on the outer face of the rim, wherein the force then exerted can break said device. Furthermore, the force exerted may in extreme cases even cause breakage of the electronic unit or the tubular core of the valve. For this, the valve must be installed in two operations, namely installation of the valve in the hole on the rim, or tyre fitting, and then mounting of the device for limiting the effect of centrifugal force. This multiplication of steps is not acceptable since it would take up too much time in production, and there may be a risk of forgetting to position the device for limiting the effect of centrifugal force after the tyre has been fitted. Another drawback of this two-stage solution is that, when screwing on the cap, the electronic unit cannot be held in place during this screwing operation since it is not accessible from inside the tyre, and it could be driven in rotation because of the torque exerted on the valve during screwing on of the cap; this could result in poor positioning of the electronic unit which would then be angled relative to a nominal position, in which it must be installed in order to ensure its functions of radiofrequency communication of temperature and pressure data to the tyre pressure monitoring system.

### SUMMARY OF THE INVENTION

The aim of an aspect of the present invention is to propose an inflation valve with limitation of centrifugal force which has none of the above-mentioned drawbacks.

To this end, an aspect of the present invention concerns an inflation valve intended for installation in an orifice of a rim for a tyre of a motor vehicle, the valve being of the type with elastic deformation and having:
a valve body made of an elastomer material, provided with a longitudinal axial bore and intended to extend through an orifice made in the rim, said valve body being made up of an elastically deformable trunk and of an abutment head for butting against the rim, which head is separated from the trunk by a neck designed to become positioned in airtight fashion in the orifice made in said rim, and
a rigid tube extending in the body of the valve extended by an assembly section in the extension of the abutment head of said valve body,
   said valve body and said hollow rigid tube being designed and assembled so as to allow an elastic deformation of the trunk of the valve body in order to allow installation of the inflation valve through the orifice of the rim.

The tyre inflation valve according to an aspect of the invention is distinguished in that it comprises a device able to be fixed on the hollow rigid tube and having a portion allowing a rotational movement of said valve in a first rotational direction when said valve is mounted in a hole of the rim, and a portion preventing the rotational movement of said valve in a second rotational direction opposite the first rotational direction, the resulting device acting as a means for limiting an elastic deformation of the valve.

The inflation valve according to an aspect of the invention affords several beneficial advantages. In particular, it avoids stretching of the rubber and hence risk of leakage during travel when the inflation valve is subjected to the effect of centrifugal force, while ensuring the integrity of the inflation valve and of the electronic unit during fitting of the tyre.

According to a preferred and advantageous exemplary embodiment, the portion of the device for limiting elastic deformation, which allows the rotational movement of said valve in a first rotational direction of said inflation valve, is formed by a partial recess of said device for limiting elastic deformation.

According to another exemplary embodiment, the portion of the device for limiting elastic deformation, which allows a rotational movement of said valve in a first rotational direction of said inflation valve, is made of a deformable material.

According to a preferred exemplary embodiment, the portion of the device for limiting elastic deformation of the valve, which prevents the rotational movement of said valve in a second rotational direction, is formed by a rigid portion dimensioned so as to bear against the outer face of the rim and constitute a rotational stoppage point which limits the effects of centrifugal force.

According to an advantageous exemplary embodiment, the device for limiting elastic deformation of the valve is designed to be screwed onto a thread fitted to said hollow rigid tube on a portion opposite the assembly section, the trunk of the valve body of elastomer material then being configured so as only to partially cover the hollow rigid tube.

According to a preferred exemplary embodiment, the hollow rigid tube comprises a shoulder in its intermediate portion between the portion with the thread for fixing the device for limiting elastic deformation of the valve, and the portion of the hollow rigid tube which is partially covered by the trunk of the valve body of elastomer material.

According to a preferred exemplary embodiment, the device for limiting the elastic deformation of the valve is formed from two elements, namely:
a first element described as asymmetric, allowing or not allowing rotation of the inflation valve in a defined rotational direction;
a second element constituting a means for fixing the first element to the inflation valve in a position ensuring limitation of elastic deformation.

According to another exemplary embodiment, the first element is composed of an L-shaped folded sheet, one arm of the L having a passage opening for the hollow rigid tube for mounting of the device for limiting elastic deformation on the inflation valve, the other arm of the L forming the portion of said device which prevents rotational movement of said valve in a second rotational direction.

According to another preferred exemplary embodiment, the first element consists of a hollow cylinder which is configured to at least partially surround the valve body of elastomer material and having an at least partial longitudinal cutout from a first of its ends intended to be positioned opposite the abutment head of the valve body of elastomer material, and at the other of its ends the cross-section of the hollow cylinder has an edge extending in the direction of the centre of the cross-section and able to bear against the shoulder of the hollow rigid tube, said edge forming in its centre a passage opening for said hollow rigid tube.

According to a preferred exemplary embodiment, the hollow rigid tube of the valve, and the passage opening for the hollow rigid tube provided in the first element of the device for limiting elastic deformation of the valve, have a complementary cross-section and shape allowing them to correspond in a specific position during assembly. Thus it is possible to ensure correct mounting of the device for limiting the elastic deformation of the inflation valve on the latter.

An aspect of the invention also concerns an assembly of a wheel rim of a motor vehicle and an inflation valve, the inflation valve being placed through an orifice of the rim and having a part outside the rim and a part inside the rim, the head of the valve body being inserted inside the rim, wherein this assembly is distinguished in that the inflation valve is produced as described above, the device for limiting elastic deformation of the inflation valve being positioned on said valve so as to limit an elastic deformation of the inflation valve, the portion preventing rotation of the valve in a defined rotational direction abutting against an outer wall of the rim close to an edge of the orifice of said rim. The abutment between the portion preventing rotation of the valve in a defined rotational direction and the outer wall of the rim is at the front, and takes place at a free end of said portion when a deformation of the valve body of elastomer material is reached for which blockage of deformation is considered necessary, and prevents the deformation from continuing.

According to an advantageous exemplary embodiment, at rest, a clearance is provided between a free end of the portion of the device for limiting elastic deformation of the inflation valve and an outer wall of the rim close to an edge of the orifice of said rim. This clearance “e” then prevents stressing the elastomer material of the valve body, in particular at the neck, and hence improves the guarantee of seal of the inflation valve.

### BRIEF DESCRIPTION OF THE DRAWINGS

Other aspects, features and advantages of the present invention will become apparent from the following description, provided by way of a non-limiting example, with reference to the appended drawings, in which:

FIGS. 1 and 2 described above respectively illustrate the problems of leakage and tearing of inflation valves of elastomer material subjected to centrifugal force.

FIG. 3 is a view in exploded perspective of a first embodiment of the inflation valve according to the invention.

FIG. 4 is a view illustrating the inflation valve from FIG. 3 in which the elements are assembled.

FIG. 5 is a longitudinal sectional view of the inflation valve from FIG. 3 shown mounted in a hole in the rim.

FIG. 6 is a view in exploded perspective of a second embodiment of the inflation valve according to the invention.

FIG. 7 is a view illustrating the inflation valve from FIG. 6 in which the elements are assembled.

FIG. 8 is a longitudinal sectional view of the inflation valve from FIG. 6 shown mounted in a hole in the rim.

FIG. 9 is a schematic, longitudinal sectional view illustrating the inflation valve from FIG. 6, associated with an electronic unit of a tyre monitoring system, shown mounted in a hole in the rim and illustrating the effects during tyre fitting.

FIG. 10 is a schematic, longitudinal sectional view illustrating the inflation valve from FIG. 6, together with an electronic unit of a tyre monitoring system, shown mounted in a hole in the rim and subjected to the effects of centrifugal force.

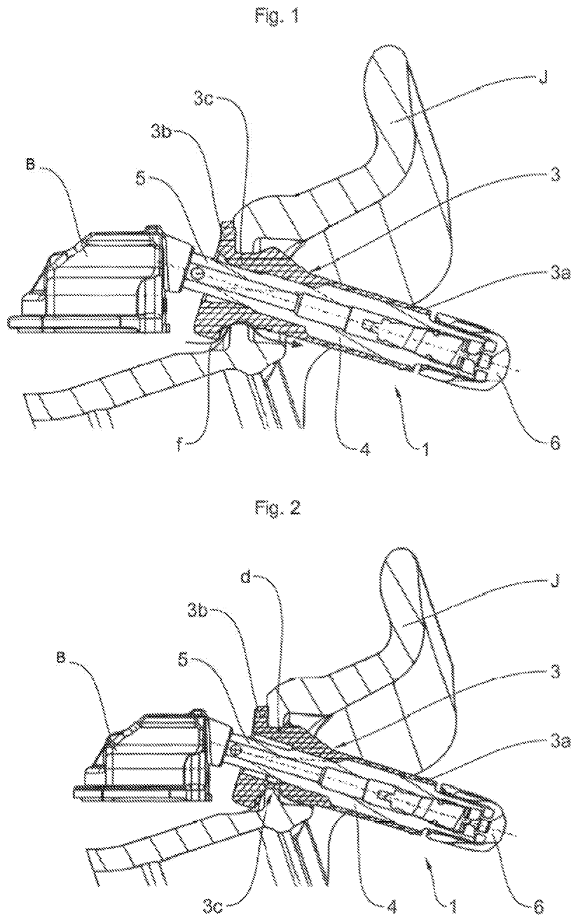

### DETAILED DESCRIPTION OF THE PREFERRED EMBODIMENTS

In the present description, elements similar to elements of different embodiments carry the same reference signs.

The inflation valve 10 with elastic deformation according to an aspect of the invention comprises, in a manner known in itself:
a valve body 30 made of an elastomer material, provided with a longitudinal axial bore and intended to extend through an orifice made in the rim J, said valve body being made up of an elastically deformable trunk 30a and of an abutment head 30b for butting against the rim J, which head is separated from the trunk by a neck 30c designed to become positioned in airtight fashion in the orifice made in said rim J, and
a hollow rigid tube 40 extending in the body of the valve 30, and extended by an assembly section 50 in the extension of the abutment head of said valve body 30.

The end of the hollow rigid tube 40 opposite the assembly section 50 is generally fitted with a thread 40a to receive a valve cap 60.

The valve body 30 and the rigid tube 40 are designed and assembled so as to allow an elastic deformation of the trunk 30a of the valve body 30 in order to allow installation of the inflation valve 10 through the orifice of the rim J.

According to an aspect of the invention, the inflation valve 10 comprises a device 70 serving as a means for limiting an elastic deformation of the valve. This device 70 for limiting an elastic deformation has a portion 70a allowing a rotational movement of the valve in a first rotational direction R1 when said valve is mounted in a hole in the rim J, and a portion 70b preventing a rotational movement of said valve in a second rotational direction R2 opposite the first rotational direction R1.

According to a preferred exemplary embodiment, the device 70 for limiting elastic deformation is designed to be screwed onto a thread fitted to said hollow rigid tube 40, on a portion opposite the assembly section 50, upstream of the end portion carrying the thread for the valve cap 60. In this embodiment, the trunk 30a of the valve body 30 of elastomer material is configured so as to only partially cover the hollow rigid tube 40.

According to an exemplary embodiment (not shown), the portion 70a of the device 70 for limiting elastic deformation, which allows rotational movement of the valve in a first rotational direction R1 of said inflation valve 10, is made of a deformable material, i.e. a material of hardness lower than that of the material constituting the rim J, so as not to offer any resistance in the case of pressure of said portion 70a against said rim J so as to move on contact with the latter.

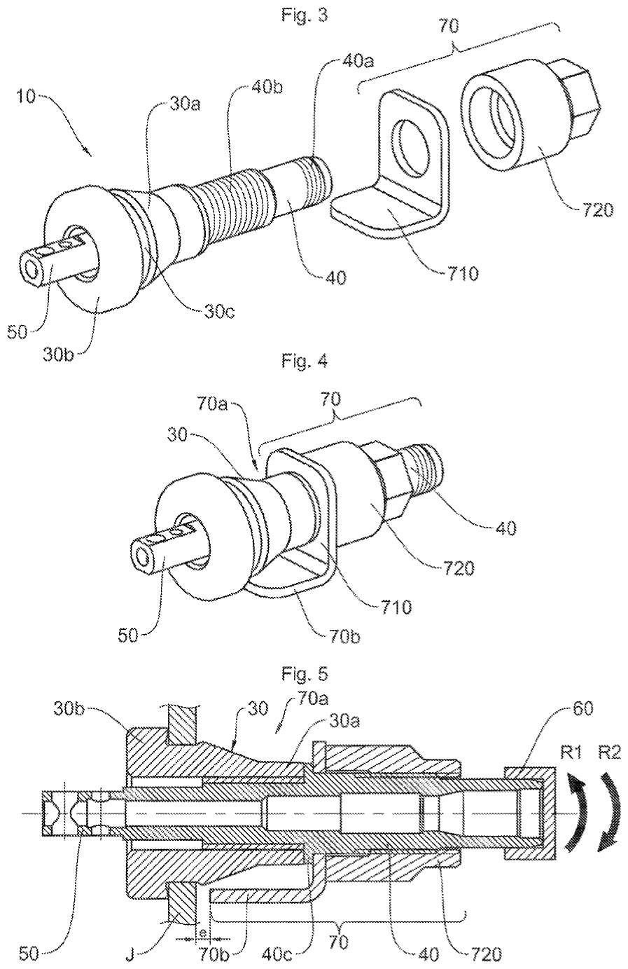

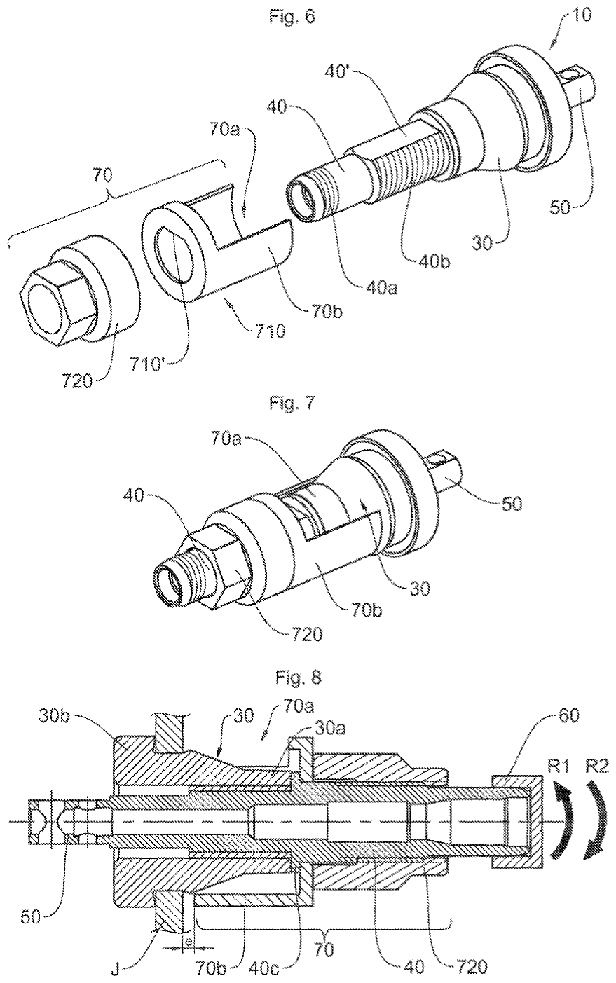

According to the advantageous exemplary embodiments illustrated in FIGS. 3 to 10, the portion 70a of the device for limiting elastic deformation, which allows a rotational movement of said valve in a first rotational direction R1 of said inflation valve, is formed by a partial recess of said device for limiting elastic deformation.

Advantageously, the portion 70a of the device 70 for limiting elastic deformation of the valve, which prevents the rotational movement of said valve in a second rotational direction R2 opposite the first rotational direction R1, is formed by a rigid portion 70b dimensioned so as to bear against the outer face of the rim J and constitute a rotational stoppage point which limits the effects of centrifugal force.

In the embodiment not shown, in which the portion 70a is formed from a deformable material, the latter may be attached to the portion 70b by any means known in itself.

The device 70 is fixed to the inflation valve 10, either permanently or removably, by any other means known in itself.

In an advantageous but not !imitative fashion, the device 70 for limiting elastic deformation of the valve 10 is designed to be screwed onto a thread 40b fitted to said hollow rigid tube 40 on a portion opposite the assembly section 50, upstream of the end portion bearing the thread 40a of the valve cap 60, the trunk 30a of the valve body 30 of elastomer material then being configured so as only to partially cover the hollow rigid tube 40.

Advantageously, the hollow rigid tube 40 comprises a shoulder 40c in its intermediate portion between the portion with the thread 40b for fixing the device 70 for limiting elastic deformation of the inflation valve 10, and the portion of said hollow rigid tube which is partially covered by the trunk 30a of the valve body 30 of elastomer material.

Preferably and advantageously, the device 70 for limiting the elastic deformation of the inflation valve 10 is formed from two elements, namely:
a first element 710 described as asymmetric, comprising the portions 70a and 70b configured respectively for allowing or not allowing rotation of the inflation valve 10 in a defined rotational direction, wherein the asymmetry is then extended along an axis transversely to the longitudinal axis of the inflation valve 10 when the device 70 is mounted on said valve; and
a second element 720 constituting a means for fixing the first element to the inflation valve 10 in a position ensuring limitation of elastic deformation of said valve.

According to the embodiment illustrated in FIGS. 3 to 5, the first element 710 is formed from an L-shaped folded sheet, one arm of the L having a passage opening for the hollow rigid tube 40 for mounting of the device 70 on the inflation valve 10, while the other arm of the L forms the portion 70b of said device 70.

As shown in FIG. 5, the arm of the L with the passage opening for the hollow rigid tube 40 is positioned against the shoulder 40c fitted to said hollow rigid tube, and the first element 710 configured in this way is held on the inflation valve 10 by the second element 720, for example formed by a nut screwed onto the hollow rigid tube 40.

According to the embodiment illustrated in FIGS. 7 to 8, the first element 710 consists of a hollow cylinder configured to at least partially surround the valve body 30 of elastomer material. This cylinder has an at least partial longitudinal cutout from a first of its ends intended to be positioned opposite the abutment head of the valve body of elastomer material, this cutout constituting the portion 70a of the device 70 for limiting an elastic deformation of the inflation valve 10, wherein the remainder of the hollow cylinder then forms the portion 70b of said device 70 preventing the rotational movement of said valve in a second rotational direction R2.

At its opposite end, the hollow cylinder has an edge extending in the direction of the centre of the cross-section of the hollow cylinder and forming in its centre a passage opening for the hollow rigid tube 40. As shown in FIG. 8, this edge is suitable for bearing against the shoulder 40c fitted to said hollow rigid tube, and the first element 710 configured in this way is held on the inflation valve 10 by the second element 720, for example formed by a nut screwed onto the hollow rigid tube 40.

To facilitate mounting of the device 70 on the inflation valve 10, the first element 710 and the second element 720 may be provisionally assembled by a connection having a torque designed to allow separation of said first and second elements, so as to guarantee mounting of the device 70 on the inflation valve 10 in a position ensuring limitation of the elastic deformation of said valve.

According to yet another exemplary embodiment (not shown), the first element 710 is formed by a skirt of plastic material overmolded onto the second element 720.

According to a preferred exemplary embodiment, the hollow rigid tube 40 of the inflation valve 10, and the passage opening for the hollow rigid tube provided in the first element 710 of the device 70 for limiting elastic deformation of the valve, have a complementary cross-section and shape, such as for example a flat 40′ and 710′, allowing them to correspond in a specific position during assembly. Thus it is possible to ensure correct mounting of the device for limiting the elastic deformation of the inflation valve on the latter.

As illustrated in FIGS. 5 and 8 to 10, when the inflation valve 10 is mounted on a rim J, the inflation valve is placed through an orifice of said rim, having a part outside the rim and a part inside the rim, and the head 30b of the valve body 30 is inserted inside the rim.

To avoid stretch forces at the neck 30c of the valve body 30 of elastomer material, which could lead to tearing of said elastomer material at said neck and hence to leaks, at rest

(FIGS. 5 and 8), a clearance “e” is provided between a free end of the portion 70b of the device 70 for limiting elastic deformation of the inflation valve 10, and an outer wall of the rim J next to an edge of the orifice of said rim. This clearance “e” then prevents stressing the elastomer material of the valve body 30, in particular at the neck 30c, and hence improves the guarantee of seal of the inflation valve 10.

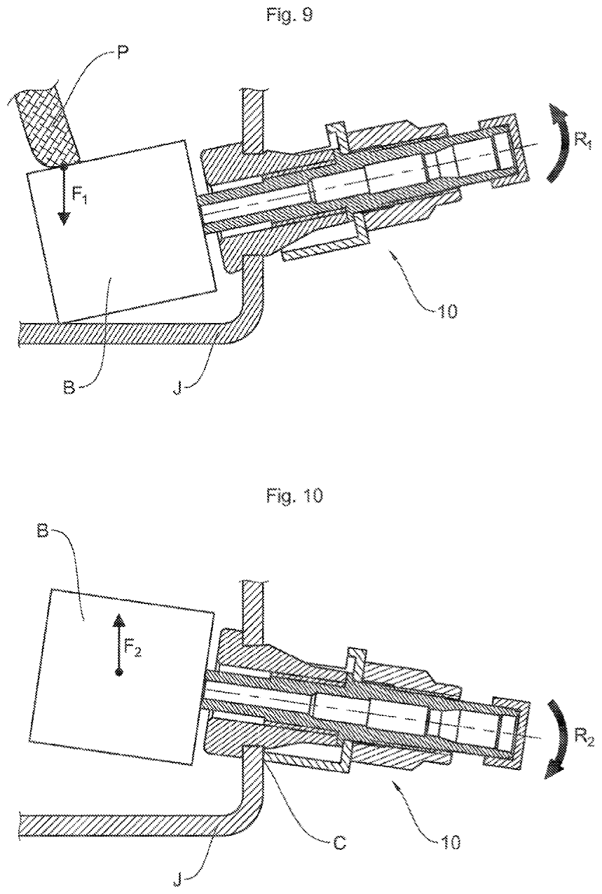

The inflation valve 10 must be positioned in the hole in the rim J such that:
as illustrated in FIG. 9, the device 70 allows a rotational movement of the inflation valve 10 in a first rotational direction R1 applied to the inflation valve 10 on the fitting of a tyre P onto said rim J, when a lip of said tyre exerts a force on an electronic unit B (associated with the inflation valve 10 via the assembly section 50) so as to move said electronic unit in the direction of the bed of the rim in the direction of arrow F1, and
as illustrated in FIG. 10, the device 70 prevents—or at least limits to a very small amount—a rotational movement of the inflation valve 10 in a second rotational direction R2 opposite the first rotational direction R1, caused by the effects of centrifugal force (in the direction of arrow F2) to which the inflation valve 10 is subjected (in particular in the case when associated with an electronic unit B), when the wheel on which it is mounted rotates, wherein a free end of the portion 70b abuts (contact C) against an outer wall of the rim J close to an edge of the orifice of said rim, when a deformation of the valve body of elastomer material is reached for which blockage of deformation is considered necessary, and thus prevents the deformation from continuing.

1. An inflation valve intended for installation in an orifice of a rim for a tyre of a motor vehicle, the valve being of the type with elastic deformation and comprising:
a valve body made of an elastomer material, provided with a longitudinal axial bore and intended to extend through an orifice made in the rim, said valve body being made up of an elastically deformable trunk and of an abutment head for butting against the rim, which head is separated from the trunk by a neck designed to become positioned in airtight fashion in the orifice made in said rim, and
a hollow rigid tube extending in the valve body, extended by an assembly section in an extension of the abutment head of said valve body, and equipped at an end opposite the assembly portion with a thread for receiving a valve cap,
said valve body and said hollow rigid tube being designed and assembled so as to allow an elastic deformation of the trunk of the valve body in order to allow installation of the inflation valve through the rim orifice, said inflation valve comprising a device able to be fixed on the hollow rigid tube and having a portion allowing a rotational movement of said valve in a first rotational direction when said inflation valve is mounted in a hole of the wheel rim, and a portion preventing the rotational movement of said valve in a second rotational direction opposite the first rotational direction, the resulting device acting as a limit of any elastic deformation of the valve,
the device for limiting the elastic deformation of the valve being formed from two elements:
an asymmetric first element, allowing or not allowing rotation of the inflation valve in a defined rotational direction; and
a second element constituting a means for fixing the first element to the inflation valve in a position ensuring limitation of elastic deformation,
the second element being separate from the valve cap.

2. The inflation valve as claimed in claim 1, wherein the portion of the device for limiting elastic deformation, which allows a rotational movement of said valve in a first rotational direction of said inflation valve, is formed by a partial recess of said device for limiting elastic deformation.

3. The inflation valve as claimed in claim 1, wherein the portion of the device for limiting elastic deformation, which allows the rotational movement of said valve in a first rotational direction of said inflation valve, is made of a deformable material.

4. The inflation valve as claimed in claim 1, wherein the portion of the device for limiting elastic deformation of the valve, which prevents the rotational movement of said valve in a second rotational direction, is formed by a rigid portion dimensioned so as to bear against the outer face of the rim and constitute a rotational stoppage point which limits the effects of centrifugal force.

5. The inflation valve as claimed in claim 1, wherein the device for limiting elastic deformation of the valve is designed to be screwed onto a thread fitted to said hollow rigid tube on a portion opposite the assembly section, the trunk of the valve body of elastomer material then being designed so as only to partially cover the hollow rigid tube.

6. The inflation valve as claimed in claim 5, wherein the hollow rigid tube comprises a shoulder in its intermediate portion between the portion with the thread for fixing the device for limiting elastic deformation of the valve, and the portion of the hollow rigid tube which is partially covered by the trunk of the valve body of elastomer material.

7. The inflation valve as claimed in claim 6, wherein the first element is composed of an L-shaped folded sheet, one arm of the L having a passage opening for the hollow rigid tube for mounting of the device for limiting elastic deformation on the inflation valve, the other arm of the L forming the portion of said device which prevents rotational movement of said valve in a second rotational direction.

8. The inflation valve as claimed in claim 6, wherein the first element comprises a hollow cylinder which is configured to at least partially surround the valve body of elastomer material and having an at least partial longitudinal cutout from a first of its ends intended to be positioned opposite the abutment head of the valve body of elastomer material, and at the other of its ends the cross-section of the hollow cylinder has an edge extending in the direction of the centre of the cross-section and able to bear against the shoulder of the hollow rigid tube, said edge forming in its centre a passage opening for said hollow rigid tube.

9. The inflation valve as claimed in claim 6, wherein the hollow rigid tube of the valve, and the passage opening for the hollow rigid tube provided in the first element of the device for limiting elastic deformation of the valve, have a complementary cross-section and shape allowing them to correspond in a specific position during assembly.

10. An assembly of a wheel rim of a motor vehicle and an inflation valve, the inflation valve being placed through an orifice of the rim and having a part outside the rim and a part inside the rim, a head of the valve body being inserted inside the rim, wherein the inflation valve is produced as claimed in claim 1, the device for limiting elastic deformation of the inflation valve being positioned on said valve so as to limit an elastic deformation of the inflation valve, the portion preventing rotation of the valve in a defined rotational direction abutting against an outer wall of the rim close to an edge of the orifice of said rim.

11. The assembly of a wheel rim of a motor vehicle and an inflation valve as claimed in claim 10, wherein at rest, a clearance is provided between a free end of the portion of the device for limiting elastic deformation of the inflation valve and an outer wall of the rim close to an edge of the orifice of said rim.
